(19) United States
(12) Patent Application Publication
(10) Pub. No.: US 2015/0074398 A1
(43) Pub. Date: Mar. 12, 2015

(54) SECURITY

(71) Applicant: BAE SYSTEMS plc, London (GB)

(72) Inventors: Alan Manuel Cullen, Chelmsford (GB); Christopher Mark Dearlove, Chelmsford (GB); Graeme Craig Jenkinson, Chelmsford (GB)

(73) Assignee: BAE SYSTEMS plc, London (GB)

(21) Appl. No.: 14/388,444

(22) PCT Filed: Mar. 27, 2013
(86) PCT No.: PCT/GB2013/050797

§ 371 Date: Sep. 26, 2014

(30) Foreign Application Priority Data
Mar. 30, 2012 (GB) 1205661.0

(51) Int. Cl. H04L 29/06; H04L 29/08

(52) U.S. Cl. CPC H04L 63/0428; H04L 67/06
USPC 713/168

(57) ABSTRACT

A method of secure information sharing between a first domain and a plurality of destination domains, the method comprising:
a. Processing a file at the first domain to establish a set of attributes of the file, the attributes of the file comprising a destination attribute for determining permitted domains to which the file may be sent,
b. Encrypting the file at the first domain using the attributes of the file, and thereby generating an encrypted file,
c. providing the first domain with, for a first destination domain, a first egress data guard comprising a destination attribute associated with the first destination domain,
d. identifying that the encrypted file is desired to be communicated to the first destination domain,
e. attempting to decrypt the encrypted file at the first egress data guard using a decryption key derived from the destination attribute of the first egress data guard, where decryption will be possible if the destination attribute of the data guard matches the destination attribute of the file,
f. if it has been possible to decrypt the encrypted file at step e, making a determination as to whether the file may be communicated to the first destination domain.

The present invention relates to a method and apparatus for secure information sharing between a first domain and a plurality of further domains, in particular but not exclusively, the method and apparatus may be for information sharing during multi-national or multi-organisational collaborations.

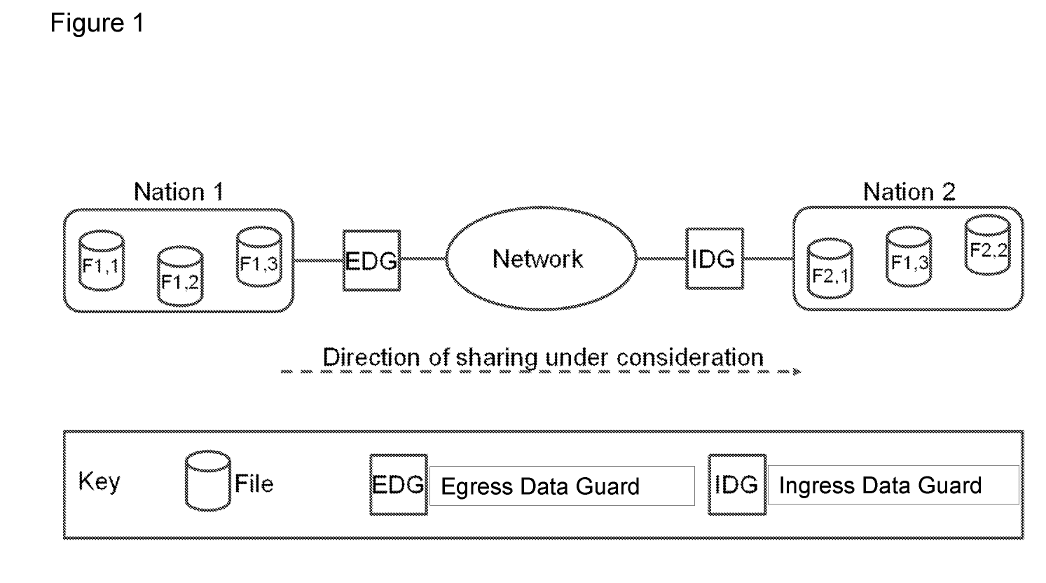

Known ways of sharing information range from ad hoc methods, for example occasional file transfers via memory sticks, to methods which are more formally supported via an infrastructure, such as illustrated in FIG. 1.

FIG. 1 illustrates schematically how a first domain (Nation 1) could generally share information with a second domain (Nation 2) via data guards (IDG, EDG) that support information assurance by checking outgoing and incoming information according to policies. In this example a file, namely F1,3, has been released by Nation 1 to Nation 2.

Attribute Based Encryption (ABE) is a known technology that supports fine grained access control cryptographically; a user can decrypt information, such as a file, only if he or she possesses a key that corresponds to attributes embedded during the encryption process.

According to a first aspect of the invention there is provided a method of secure information sharing between a first domain and a plurality of destination domains, the method comprising: processing a file at the first domain to establish a set of attributes of the file, the attributes of the file comprising a destination attribute for determining permitted domains to which the file may be sent, encrypting the file at the first domain using the attributes of the file, and thereby generating an encrypted file, providing the first domain with, for a first destination domain, a first egress data guard comprising a destination attribute associated with the first destination domain, identifying that the encrypted file is desired to be communicated to the first destination domain, attempting to decrypt the encrypted file at the first egress data guard using a decryption key derived from the destination attribute of the first egress data guard, where decryption will be possible if the destination attribute of the data guard matches the destination attribute of the file, if it has been possible to decrypt the encrypted file at the previous step, making a determination as to whether the file may be communicated to the first destination domain.

As such the egress data guard is unable to decrypt a file that does not have the destination attribute corresponding to the destination domain and, in such circumstances, cannot communicate an unencrypted version of the file.

Further, the above method can tend to obviate the need for a central key authority. As such, the above method may tend to be suited to collaborations between domains where it may be difficult to establish a global key authority for all domains (for example because there may not be enough trust amongst all domain parties) because each destination domain may select their level of interoperability with the first domains according to their relationship with the first domain.

The method may comprise providing, that at least one of the plurality of destination domains is predetermined, or may provide that each of the plurality of destination domains is predetermined. For example a destination domain (or a plurality thereof) and the first domain may be identified as having a need to regularly exchange data.

The method may comprise providing for each of the predetermined destination domains, at least one uniquely associated egress data guard. This may be useful in a many-to-one arrangement. For example, where a first domain wishes to share data according to different rules depending on the type of data to be shared (such as picture files, files, executable programmes, text files) an egress data guard may be set up for each type of data, each egress data guard being operable connected to the destination domain.

Alternatively, there may be provided, for each of the predetermined destination domains, a single uniquely associated egress data guard. As such, all data passing between the first domain and the predetermined destination domain would pass through the same egress data guard.

By thus having one egress data guard (or one group of data guards) for each destination domain, and each destination domain being interfaced with its associated data guard but not others, the management of data distribution can be further controlled for each destination domain and according to the circumstances surrounding the interface between the first domain and the destination domains.

In some circumstances it may be possible to have a method that provides for the communication from the first domain to two or more destination domains via a common egress data guard. However, in such instances, there is a risk of files intended for one such destination domain being transferred inadvertently, perhaps through human error, to an inappropriate destination domain. Consequently, such a method may be suitable where the destination domains with the common egress data guard are sufficiently integrated in other ways (e.g. both destination domains are within the same government, or both destination domains are from politically close organisations/nations) that the negative consequences of an inadvertent miss-transfer, are mitigated.

If it is possible to decrypt the file at the relevant step, the file is permitted to be sent to the destination domain. Alternatively, if it is possible to decrypt at the relevant step, the decrypted file is scanned according to an egress policy.

The method may further comprise: sending the encrypted file to the first destination domain; providing at least one ingress data guard at the first destination domain for determining whether the encrypted file may be received from the first domain into the first destination domain; and communicating a destination decryption key from the first domain to the first destination domain, for selectively enabling the decryption of the file at the first destination domain.

For example, the destination decryption key may selectively enable the decryption based on the attributes of a sub-destination within the destination domain.

As such users in the destination domain who have not been issued with the decryption keys cannot decrypt any of the encrypted files that are received at the destination domain.

Further, eavesdroppers to the communications between the first domain and the destination domain cannot decrypt any of the encrypted files that are desired to be communicated from the first domain and received into the destination domain.

The method may further comprise: providing, for a second destination domain, a second egress data guard at the first domain, the second egress domain comprising a destination attribute associated with the second destination domain; providing the second egress data guard with the capability to analyse the attributes of a file according to an attribute scheme of the second destination domain and an encryption key derived from the attributes of the second destination domain; re-encrypting the file using the encryption key derived from the attributes of the second destination domain; providing an ingress data guard at the second destination domain for determining whether the encrypted file that is desired to be communicated may be received from the first domain into the second destination domain; and providing the ingress data guard with a decryption key derived from an attribute of the second destination domain, wherein users in the second destination domain issued with a decryption key for the second destination domain have the capability to decrypt some of the re-encrypted files that are desired to be communicated from the first domain and received into the further domain.

Typically the first domain and destination domain will be separate administrative domains. As such each may be a private network and/or Local Area Network (LAN). The network may be accessed through a Network Address Translation (NAT) arrangement. The network may be behind a firewall. Further, each domain may be associated with an organisation or department within an organisation. Such organisations may be in particular a government, a University, or a corporation. Thus the invention should tend to facilitate secure inter-organisational sharing of data.

According to a second aspect of the invention there is provided an apparatus arranged to carry out the first aspect of the invention.

According to a third aspect of the invention there is provided a carrier medium for carrying a computer readable code arranged to control a computing device to carry out the method according to any one of the first aspect of the invention.

According to a fourth aspect of the invention, there is provided a system for secure information sharing between a first domain and a plurality of destination domains, the first domain comprising: A. an attribute identification module for processing a file at the first domain to establish a set of attributes of the file, the attributes of the file comprising a destination attribute for determining permitted domains to which the file may be sent, B. an encryption module for encrypting the file at the first domain using the attributes of the file, and thereby generating an encrypted file, C. a first egress data guard for a first destination domain, comprising a destination attribute associated with the first destination domain, wherein, upon identifying that the encrypted file is desired to be communicated to the first destination domain, the system attempts to decrypt the encrypted file at the first egress data guard using a decryption key derived from the destination attribute of the first egress data guard, where decryption will be possible if the destination attribute of the data guard matches the destination attribute of the file, such that if it has been possible to decrypt the encrypted file at step, it is thereby determined whether the file may be communicated to the first destination domain.

It will be understood that different aspects of the present invention may be combined where the context allows.

As such, users in the second destination domain not issued with the decryption keys cannot decrypt some of the encrypted files communicated to the second destination domain.

Further, eavesdroppers to the communications between the first domain and the further domain cannot decrypt any of the encrypted files that are communicated between the domains (i.e. over an intermediate network).

Overall, the ABE-scheme of the invention can tend to promote interoperability. Domains utilising the invention (e.g. nations in a military coalition) may adopt information sharing using different toolsets (e.g. one toolset may be modelled on the first destination scheme, another may be modelled on the second destination scheme) at different rates, so “one size fits all” solutions are not appropriate.

Further, the invention can tend to promote flexibility in information sharing policy. Policy must reflect differing domain requirements including the complexities of the information held. For example, the potential complexity of policies amongst a group of domains may encompass issues such as national security, export rules, and confidential information. Consequently, the ABE scheme of the present invention may tend to be scalable. The scheme may provide a broad attribute set, which would tend to further enhance the flexibility.

Still further, the invention can tend to promote information assurance. Confidentiality, integrity, availability, authentication and non-repudiation all apply in a complex environment where the threats vary from inadvertent user errors to the advanced persistent threat.

The applicant has demonstrated ABE to have an effective strength equivalent to 128 bit Advanced Encryption Standard (AES 128). Integrity and non-repudiation could be satisfied with the additional use of digital signatures. Authentication lies in the process of handling keys and is also implicit in the use of digital signatures. Availability is largely comparable with other approaches although the vulnerability of requiring real-time access to the key authority by some schemes is improved by ABE.

In addition to these factors there are a number of further behaviours with which the invention is compatible, including: useability—where encryption is built into a user's workflow, so that users avoid the temptation to find short cuts; and low overheads—because resources may be limited.

As such the present invention, through employing an ABE-type scheme tends to provide a minimised attack surface for malware to exploit, compared to alternative access control methods such as access control lists.

Further, the present invention tends to reduce the access required by the users to a server authority, as compared to alternative access control methods such as rights management schemes.

The invention may apply soft revocation by incorporating a date in keys and attributes and, when possible, it is also recommended that access patterns to encrypted material are monitored. Alternatively the invention may apply hard revocation where development of non-monotonic policies, for example ‘RESTRICTED and not REVOKED USER’.

As an alternative or compliment to recovation, Trusted Computing methods may be used to control access to ABE keys.

An information sharing infrastructure such as provided by the invention may reduce latency and offer the opportunity to optimise security through carefully planned measures related to the expected threats.

So that the invention may be well understood, at least one embodiment shall be described by way of example and with reference to the following figures, of which:

FIG. 1 shows a schematic diagram of how a first domain may share information with a second domain;

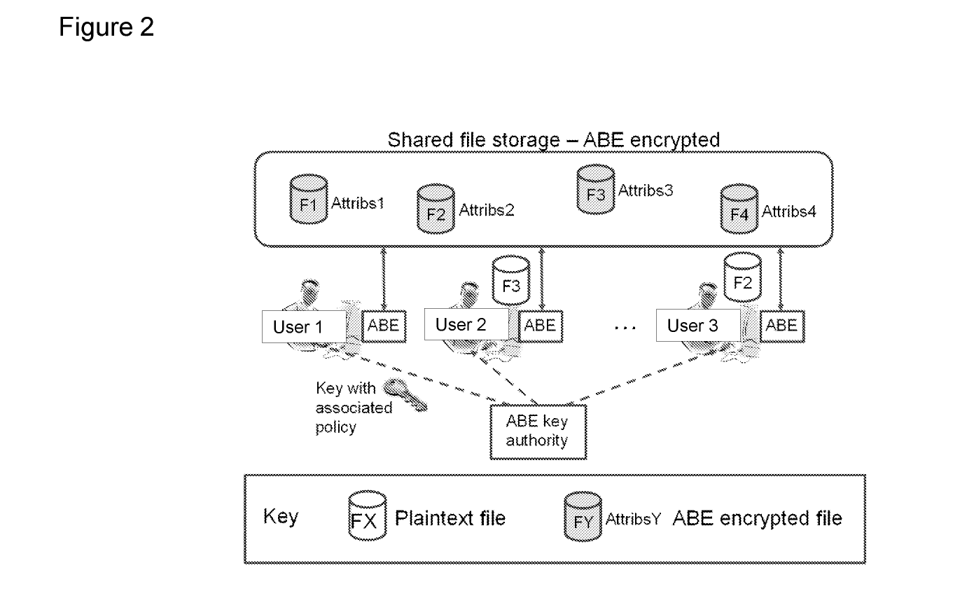

FIG. 2 shows a schematic diagram of how an Attribute Based Encryption scheme may share files between users; and

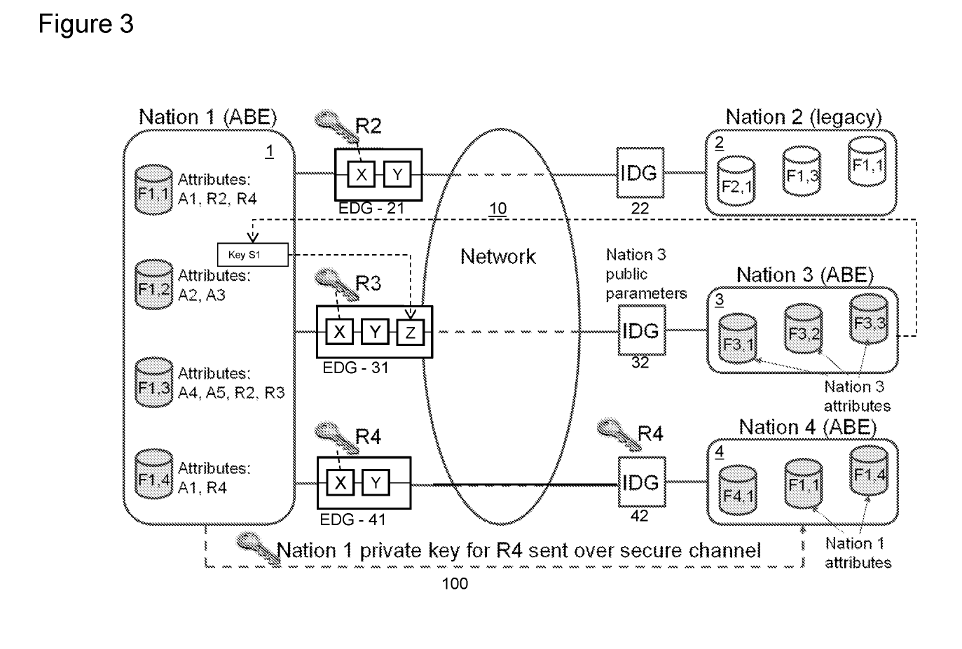

FIG. 3 shows a schematic diagram of how an Attribute Based Encryption scheme may operate amongst plurality of domains, some domains being legacy (i.e. not using ABE) and others adopting different approaches to their use of the ABE scheme.

ABE is a cryptographic technology where encryption and keys are expressed in terms of attributes. There are two main methods of ABE according to how attributes and policies are applied. In the present embodiment, Key Policy ABE, where policy is stored in keys, has been used. An alternative form of ABE, called Ciphertext Policy ABE, may also be suitable.

When a file is encrypted it is assigned attributes which are arbitrary pieces of text that are meaningful within the policies of the organisation that encrypts the file, e.g. a document, document X, could be assigned the following attributes: INFO_SHARING, 2012, UNCLASSIFIED, EXPORTABLE.

ABE is a form of public key cryptography. Encryption requires ABE system parameters, generated in advance by a key authority, and a decision about which attributes to apply. Decryption requires ABE system parameters together with a private key generated by the key authority. This key must not be revealed to other users. The private key embeds policies such as:

Policy1: (UNCLASSIFIED or RESTRICTED)

Policy2: (INFO_SHARING and EXPORTABLE and 2011)

In these examples a key for Policy1 could decrypt the encrypted version of document X while a key for Policy2 could not.

As illustrated in FIG. 2, once users have been equipped with their cryptographic information then access to the key authority is no longer required, thus reducing the probability of a server compromise. The authority will only be required when user's rights are changed, for example after promotion, or to refresh date sensitive attributes. This approach also tends to reduce the need for a high performance server and tends to be tolerant to downtime.

ABE tends to be readily scalable. The previous example used just a few attributes but the full set may be as large as desired. The cost is low in that the ciphertext overheads only increase linearly with the number of attributes applied.

ABE tends to prevent collusion. For example a user with the key (INFO_SHARING and EXPORTABLE and 2011) could not collude with a user with the key (INFO_SHARING and UK and 2012) to decrypt the encrypted version of the aforementioned document X.

Further, ABE supports delegation of keys. For example a user with the key (INFO_SHARING or EXPORTABLE) could delegate the key (INFO_SHARING and EXPORTABLE) to somebody deemed to have the need, and this can be carried out without access to the key authority. The mathematics behind ABE are described in V. Goyal et al, “Attribute-Based Encryption for Fine-Grained Access Control of Encrypted Data”, 2006, Cryptology ePrint Archive, Report 2006/309, http://eprint.iacr.org/2006/309.pdf together with a proof of security.

Referring to FIG. 3, there is shown a first domain 1, representing the computer storage resource of a first nation Nation 1, which holds four files: F1,1; F1,2; F1,3 and F1,4. File F1,1 has attributes A1, R1 and R4. File F1,2 has attributes A2, A3. File F1,3 has attributes A4, A5, R2 and R3. File F1,4 has attributes A1 and R4.

Such attributes may be identified by an attribute identification module (not shown) implemented within the network. Such a module may scan each file to establish the attributes, and/or may rely on predetermined meta-data which has been associated with the file at generation.

Typically, the first domain 1 is provided with an encryption module (not shown) for encrypting files according to, amongst other things, the identified attributes.

Also shown are three further domains. A second domain 2 represents the computer storage resource of Nation 2. The second domain 2 holds the following files: F2,1; F1,3; and F1,1.

A third domain 3 represents the computer storage resource of Nation 3. The third domain 3 holds the following files: F3,1; F3,2; and F3,3.

A fourth domain 4 represents the computer storage resource of Nation 4 and holds the following files: F4,1; F1,1; and F1,4.

The first domain 1 is connected to each of the other domains 2, 3, and 4 across a network 10.

File attributes R2, R3 and R4 are destination attributes which permit the egress of a file having that attribute to the associated domain. For example, File F1,3 has destination attributes R2 and R3 and accordingly may be sent to Nation 2 and/or Nation 3.

The first domain 1 is provided with a specific egress data guard for each specific domain. The egress data guard vets any file which is to be communicated to its associated domain. More specifically, each egress data guard is provided to appropriately decrypt (at X) a file for communication and optionally scan (at Y) the consequently unencrypted file according to further policies.

A first egress data guard 21 is provided for vetting files which may be identified as ‘for communication to the second domain 2’. The first egress data guard is provided with a decryption key R2, derived from the associated file destination attribute R2, and suitable for decrypting encrypted files with the R2 destination attribute.

A second egress data guard 31 is provided for vetting files which may be identified as ‘for communication to the third domain 3’. The second egress data guard 31 is provided with a decryption key R3 is derived from the associated file destination attribute R3, and suitable for decrypting encrypted files with the R3 destination attribute. The second egress data guard 31 is further provided with a station Z which is able to re-encrypt the file (previously decrypted at X and scanned at Y) using public key information and attributes S1 that have been supplied from Nation 3. Thus an encrypted file may be communicated from Nation 1 to Nation 3 where, of the destination Nations, only Nation 3 can decrypt the file.

A third egress data guard 41 is provided for vetting files which may be identified as ‘for communication to the fourth domain 4’. Files may be sent to the fourth domain 4 encrypted according to the scheme of the first domain 1.

In a corresponding manner, each of second 2, third 3 and fourth 4 domains, being destination domains, are provided with an ingress data guard, 22, 32, 42 respectively, for receiving and vetting the incoming files from the first domain 1 in accordance with the policies of that particular destination domain.

The first domain 1 and the fourth domain 4 are further connected by secure channel 100 such that a private key for the ingress data guard 42 may be sent to the fourth domain 4 from the first domain 1.

In operation, ABE may be used independently by adopting domains (Nations), and these domains (Nations) interoperate with other domains (Nations) using alternative and/or legacy approaches.

FIG. 3, shows several cases of sharing by an ABE-equipped first domain, Nation 1. In each case, information leaves Nation 1 via egress data guards that are assigned keys with policies R2, R3, R4 for egress to Nation 2, 3 and 4 respectively. These keys are provided because egress checks, for example a scan to confirm absence of sensitive keywords, need to be performed upon unencrypted text. However this approach has the effect that in the event of an error by a data guard, the worst case scenario would result in unencrypted material already intended to be releasable to the associated Nation being leaked.

Nations may choose to carry out further checks of incoming material in ingress data guards. In FIG. 3, Nation 2, assumed to be operating under a legacy scheme, will receive information in unencrypted format (e.g. file F1,1), scan it and then store it according to its processes.

In contrast Nation 3 uses an ABE scheme, albeit an ABE scheme independent of the Nation 1 ABE scheme. Once again material is received unencrypted (e.g. file F1,3) at the ingress data guard 32 and scanned, but material is now encrypted by the ingress data guard 32 according to Nation 3's policies. In general the ABE attribute set used by Nation 3 will be different to the Nation 1 set and there is scope for work on mapping attribute sets.

The transmissions from Nation 1 to Nation 2 and from Nation 1 to Nation 3 can carry unencrypted files so some form of communications confidentiality should be deployed between the Nations.

Alternatively, measures may be taken to provide a more encrypted communication scheme.

In particular, in the case of Nation 3 there is an alternative approach whereby the egress data guard 32 from Nation 1 re-encrypts files for Nation 3 thus reducing the need for communications confidentiality. This requires access to ABE public parameters for Nation 3 so would tend not to constitute a security risk. If Nation 1 includes an R1TO3 attribute in all material re-encrypted for Nation 3 then this facilitates a simple R1TO3 policy at the ingress data guard 32 for ingress scanning purposes.

Further, there is a second scenario for file sharing between ABE Nations where the material is not re-encrypted and instead keys are delegated. In the final case illustrated in FIG. 3, Nation 1 issues the private key for policy R4 to Nation 4 and Nation 4 then delegates this key to users, e.g. a Nation 4 user could be assigned policy (A1 and R4) and this would permit access to file F1,4. The ingress data guard 42 of Nation 4 accesses and uses the private key for R4 accordingly. This scenario would tend to provide cryptographic simplicity, but would require the management of multiple key and attribute systems by a single Nation.

The applicant has developed a prototype for demonstrating ABE in a cloud based information sharing scenario. The prototype, implemented in C++ and using the MIRACL library (see MIRACL Crypto SDK, as provided by CertiVox, for example as may be available occasionally via the certivox.com website and at http://certivox.com/index.php/solutions/miracl-crypto-sdk/) for the cryptographic primitives, supports both key policy and ciphertext policy methods.

It is known to use public key systems to bootstrap symmetric key systems for performance reasons. The applicant's prototype follows this approach by encrypting the plaintext using a random AES key and then using ABE to encrypt the AES key which is included in the ciphertext.

In the prototype, 128 bit security was implemented using AES-128 and asymmetric pairings over Barreto-Naehrig curves supported by MIRACL. The performance of the software implementation was around 60 ms to encrypt a file with three attributes (i.e. A, B, C) and around 130 ms to decrypt the file with a policy covering all three attributes (i.e. A and B and C). These times were measured on an Intel® E8400 processor running single-threaded at 3.0 GHz.

The total ciphertext overhead with three attributes, including the encrypted AES key and padding, was around 400 bytes.

Throughout the specification, various terms have been used to denote features. However, the skilled man would understand that various equivalent terms may apply to these.

In particular, the skilled man would understand attribute based encryption to include encryption schemes based around any permutation or combination of attributes, labels, index terms, meta data and/or the properties of the encrypted information. Further, attribute based encryption schemes would also be understood to include such schemes employing encrypted attributes and automated redaction.

Moreover the skilled man would understand that attribute based encryption schemes could be developed having effective strengths greater than or less than the 128 bit Advanced Encryption Standard (AES-128) and/or with revocation schemes different to the soft method described above.

Further, whilst the above embodiment has been primarily concerned with the sharing of information amongst the domains of specific Nations, the invention would be applicable to various other or equivalent domains such as inter-organisations, inter-platform, inter-security domains (such as between an intranet and the internet or between an unclassified domain and a classified domain). Further, encrypted information could be stored (e.g. in a cloud-type computing arrangement) rather than being passed directly between organisations.

Still further, the skilled man would understand that the invention could be worked on any type of digital information file such as e-mail, records, text, documents, presentations, multimedia, knowledge, audio files, video files, and software.

Also, whilst the embodiment shown in FIG. 3 provides a unique egress data guard for each destination domain, in variants of the invention, other connection arrangements between egress data guards and destination domains are contemplated.

For instance, a group of distinct egress data guards may be provided at the first domain and be arranged such that each egress data guard within the group is connected to the same destination domain. Such an arrangement could be implemented to allow different types of digital information file to be handled differently between the first and destination domains. For example, in order to control information exchange, e-mails could be handled by a first generally permissive egress data guard, whilst video files could be handled by a more restrictive egress data guard.

As a further instance of a variant connection arrangement, two or more different destination domains may be connected to the first domain via a common egress data guard. Such an arrangement could reduce the complexity of the system but may allow inadvertent transmission of data to an unintended destination domain sharing the egress data guard. Thus such an arrangement may be suitable where the relationship between the destination domains is sufficiently collaborative and trusting that the negative impact of an inadvertent transmission should tend to be mitigated.

In further variants of the above embodiment, release attributes could be replaced by other release policies that could for example be used to distinguish between multiple egress data guards connected to the same destination domain.

In still further variants, the attribute based encryption can also be applied to scenarios where the destination domain is not determined until encryption time or even later, for example by being left in a ‘to be determined’ state awaiting a subsequent decision.

Moreover, the skilled man would appreciate that the vetting or scanning procedures carried out by the egress and ingress data guards would include, but not be limited to packet inspection, deep packet inspection, flow inspection, deep flow inspection, re-rendering, format conversion, proxies and sandboxes.

1. A method of secure information sharing between a first domain and a plurality of destination domains, the method comprising:
processing a file at the first domain to establish a set of attributes of the file, the attributes of the file comprising a destination attribute for determining permitted domains to which the file may be sent;
encrypting the file at the first domain using the attributes of the file, and thereby generating an encrypted file;
providing the first domain with, for a first destination domain, a first egress data guard comprising a destination attribute associated with the first destination domain;
identifying that the encrypted file is desired to be communicated to the first destination domain;
attempting to decrypt the encrypted file at the first egress data guard using a decryption key derived from the destination attribute of the first egress data guard, where decryption will be possible if the destination attribute of the data guard matches the destination attribute of the file; and
if it has been possible to decrypt the encrypted file, making a determination as to whether the file may be communicated to the first destination domain.

2. A method according to claim 1 wherein at least one of the plurality of destination domains is predetermined.

3. A method according to claim 1 wherein each of the plurality of destination domains is predetermined.

4. A method according to claim 2 further comprising providing, for each of the predetermined destination domains, at least one uniquely associated egress data guard.

5. A method according to claim 1 further comprising providing, for each of the predetermined destination domains, a single uniquely associated egress data guard.

6. The method according to claim 1 wherein if it is possible to decrypt the encrypted file, the file is permitted to be sent to the destination domain.

7. The method according to claim 1 wherein if it is possible to decrypt the encrypted file, the decrypted file is scanned according to an egress policy.

8. A method secure information sharing between a first domain and a plurality of destination domains, the method comprising:
processing a file at the first domain to establish a set of attributes of the file, the attributes of the file comprising a destination attribute for determining permitted domains to which the file may be sent;
encrypting the file at the first domain using the attributes of the file, and thereby generating an encrypted file;
providing the first domain with, for a first destination domain, a first egress data guard comprising a destination attribute associated with the first destination domain;
identifying that the encrypted file is desired to be communicated to the first destination domain;
attempting to decrypt the encrypted file at the first egress data guard using a decryption key derived from the destination attribute of the first egress data guard, where decryption will be possible if the destination attribute of the data guard matches the destination attribute of the file;
if it has been possible to decrypt the encrypted file, making a determination as to whether the file may be communicated to the first destination domain;
sending the encrypted file to the first destination domain;
providing at least one ingress data guard at the first destination domain for determining whether the encrypted file may be received from the first domain into the first destination domain;
communicating a destination decryption key from the first domain to the first destination domain, for selectively enabling the decryption of the file at the first destination domain.

9. A method according to claim 1 further comprising:
providing, for a second destination domain, a second egress data guard at the first domain, the second egress domain comprising a destination attribute associated with the second destination domain;
providing the second egress data guard with
the capability to analyse the attributes of a file according to an attribute scheme of the second destination domain, and
an encryption key derived for the second destination domain;
re-encrypting the file using the encryption key applied to the attributes of the second destination domain;
providing an ingress data guard at the second destination domain for determining whether the encrypted file that is desired to be communicated may be received from the first domain into the second destination domain;
providing the ingress data guard with a decryption key derived from an attribute of the second destination domain;
wherein users in the second destination domain issued with a decryption key for the second destination domain have the capability to decrypt some of the re-encrypted files that are desired to be communicated from the first domain and received into the further domain.

10. A method according to claim 1 wherein each predetermined destination is an organisation or department within an organisation.

11. A method according to claim 10 wherein the organisation operates an internal network.

12. An apparatus arranged to carry out the method according to claim 1.

13. One or more non-transient computer-readable mediums encoded with instructions that when executed cause one or more processors to carry out a process of secure information sharing between a first domain and a plurality of destination domains, the process comprising:
processing a file at the first domain to establish a set of attributes of the file, the attributes of the file comprising a destination attribute for determining permitted domains to which the file may be sent;
encrypting the file at the first domain using the attributes of the file, and thereby generating an encrypted file;
providing the first domain with, for a first destination domain, a first egress data guard comprising a destination attribute associated with the first destination domain;
identifying that the encrypted file is desired to be communicated to the first destination domain;
attempting to decrypt the encrypted file at the first egress data guard using a decryption key derived from the destination attribute of the first egress data guard, where decryption will be possible if the destination attribute of the data guard matches the destination attribute of the file;
if it has been possible to decrypt the encrypted file, making a determination as to whether the file may be communicated to the first destination domain.

14. A system for secure information sharing between a first domain and a plurality of destination domains, the first domain comprising:
an attribute identification module for processing a file at the first domain to establish a set of attributes of the file, the attributes of the file comprising a destination attribute for determining permitted domains to which the file may be sent;
an encryption module for encrypting the file at the first domain using the attributes of the file, and thereby generating an encrypted file; and
a first egress data guard for a first destination domain, comprising a destination attribute associated with the first destination domain;
wherein, upon identifying that the encrypted file is desired to be communicated to the first destination domain, the system attempts to decrypt the encrypted file at the first egress data guard using a decryption key derived from the destination attribute of the first egress data guard, where decryption will be possible if the destination attribute of the data guard matches the destination attribute of the file, such that if it has been possible to decrypt the encrypted file at step, it is thereby determined whether the file may be communicated to the first destination domain.

15. The method according to claim 6 wherein the file is permitted to be sent to the destination domain unencrypted.

16. The method according to claim 8 wherein if it is possible to decrypt the encrypted file, the file is permitted to be sent to the destination domain as one of encrypted or unencrypted.

17. The method according to claim 8 wherein if it is possible to decrypt the encrypted file, the decrypted file is scanned according to an egress policy.

18. The system according to claim 14 wherein if it is possible to decrypt the encrypted file, the file is permitted to be sent to the destination domain.

19. The system according to claim 14 wherein if it is possible to decrypt the encrypted file, the file is permitted to be sent to the destination domain unencrypted.

20. The system according to claim 14 wherein if it is possible to decrypt the encrypted file, the decrypted file is scanned according to an egress policy.
